(19) United States
(12) Patent Application Publication
(10) Pub. No.: US 2010/0057961 A1
(43) Pub. Date: Mar. 4, 2010

(54) NETWORK DEVICE AND DATA TRANSMITTING METHOD

(75) Inventors: HAN-PING MI, Tu-Cheng (TW); QUAN-CHUAN CHOU, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/406,041

(22) Filed: Mar. 17, 2009

(30) Foreign Application Priority Data
Sep. 2, 2008 (CN) 200810304342.7

(51) Int. Cl. G06F 13/40

(52) U.S. Cl. 710/110

(57) ABSTRACT

A network device includes a data bus, a plurality of signal control lines, a plurality of line cards, and a management card. The plurality of line cards corresponds to the plurality of signal control lines and each line card connects to one corresponding signal control line. The management card transmits data to the line cards by way of the data bus and transmits control signals to the line cards by way of the signal control lines. The plurality of line cards accept the data from the management card by way of the data bus according to the control signals from the signal control lines.

### BACKGROUND

1. Technical Field

Embodiments of the present disclosure relate to network communications, and more particularly to a network device and a method for transmitting data.

2. Description of Related Art

A carrier grade network device in a central office includes a management card and a plurality of line cards whose number is changeable. Each line card has a unique address. The network device usually transmits data and addresses via one data bus to the plurality of line cards, so the plurality of line cards needs to decode the address via an address decoding circuit in order to accept the data. However, the aforementioned method is time consuming, and accordingly the efficiency of transmitting data is reduced. In addition, the management card needs to configure a unique address for a newly added line card before transmitting data to the newly added line card, which is inconvenient.

Therefore, a heretofore unaddressed need exists for a network device to overcome the aforementioned deficiencies and inadequacies.

### BRIEF DESCRIPTION OF THE DRAWINGS

The details of the present disclosure, both as to its structure and operation, can best be understood by referring to the accompanying drawings, in which like reference numbers and designations refer to like elements.

FIG. 1 is a schematic diagram of one embodiment of functional modules of a network device of the present disclosure;

FIG. 2 is a flowchart of another embodiment of a data transmitting method in accordance with the present disclosure; and

FIG. 3 is a detailed flowchart of the data transmitting method showed in FIG. 2.

### DETAILED DESCRIPTION OF CERTAIN INVENTIVE EMBODIMENTS

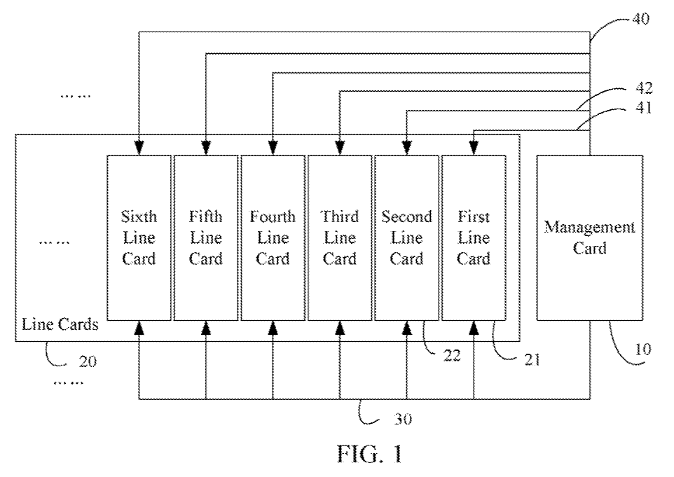

FIG. 1 is a schematic diagram of one embodiment of functional modules of a network device of the present disclosure. In the embodiment, the network device is a carrier grade network device in a central office, such as a voice/data access gateway.

In the embodiment, the network device comprises a management card 10, a plurality of line cards 20, a data bus 30, and a plurality of signal control lines 40. The plurality of line cards comprise a first line card 21, a second line card 22, and so on. The plurality of signal control lines 40 comprise a first signal control line 41, a second signal control line 42, and so on.

The data bus 30 connects the management card 10 to the plurality of line cards 20 and is configured for transmitting data from the management card 10 to the plurality of line cards 20. The data bus 30 may be, for example, an inter integrated circuit (I²C) data bus. One end of the data bus 30 is connected to the management card 10 and another end of the data bus 30 is connected to the plurality of line cards 20.

The plurality of signal control lines 40 each connect one of the line cards 20 to the management card 10 for transmitting control signals from the management card 10 to corresponding line cards 20. For example, the first line card 21 is connected to the management card 10 by the first signal control line 41, the second line card 22 by the second signal control line 42, and so on. The signal control lines 40 may be chip selection lines, for example.

The management card 10 is configured for transmitting data to the line cards 20 by way of the data bus 30 and transmitting control signals to the line cards 20 by way of the corresponding signal control lines 40. In the embodiment, the control signals are 1's and 0's, namely high and low level signals.

In the embodiment, if the management card 10 needs to transmit data to one line card 20, the management card 10 transmits a first control signal to the line card 20 by way of the corresponding signal control line 40. If the management card 10 does not need to transmit the data to the line card 20, the management card 10 transmits a second control signal to the line card 20 by way of corresponding signal control line 40. For example, the management card 10 needs to transmit the data to the first line card 21 and does not need to transmit the data to the second line card 22, the management card 10 transmits the first control signal to the first line card 21 by way of the first signal control line 41, and then transmits the second control signal to the second line card 22 by way of the second signal control line 42. The first control signal and the second control signal are predetermined to be two different control signals. For example, if the high level signal of 1 is predetermined to indicate data transmission and the low level signal of 0 is predetermined to indicate no data transmission, then the first control signal is 1 and the second control signal is 0.

The plurality of line cards 20 is configured for executing various functions of the network device. In the embodiment, the plurality of line cards 20 is configured for accepting the data from the management card 10 by way of the data bus 30 according to the control signals from the signal control lines 40. Whether the line cards 20 accept the data transmitted by the management card 10 is determined by the control signals received by the line cards 20 over the corresponding signal control line 40 from the management card 10. In the embodiment, each line card detects the control signal from the corresponding signal control line, accepts the data by way of the data bus 30 upon the condition that the detected control signal is the first control signal, and does not accept the data by way of the data bus 30 upon the condition that the detected control signal is the second control signal. For example, if the first line card 21 detects the first control signal from the first signal control line 41, the first line card 21 accepts the data transmitted from the management card 10 by way of the data bus 30. If the second line card 22 detects the second control signal from the first signal control line 42, the second line card 22 does not accept the data by way of the data bus 30. As such, the management card 10 rapidly finds the line card 20 that needs to accept the data from the management card 10 via the signal control lines 40, and the network device does not need to decode the address of the line card 20, thereby improving the efficiency of transmitting data.

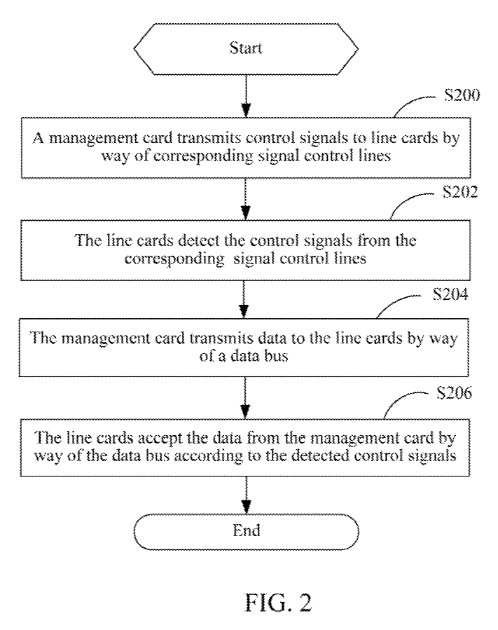

FIG. 2 is a flowchart of another embodiment of a data transmitting method in accordance with the present disclosure. In the embodiment, the data transmitting method is performed by the function modules of the network device depicted in FIG. 1. It may be understood that additional steps may be added, others may be removed, and ordering of the steps may be changed depending on the embodiment.

In step S200, the management card 10 transmits control signals to the line cards 20 by way of the corresponding signal control lines 40.

In step S202, the line cards 20 detect the control signals from the corresponding signal control lines 40.

In step S204, the management card 10 transmits data to the line cards 20 by way of the data bus 30. The data bus 30 may be, for example, an inter integrated circuit (I²C) data bus.

In step S206, the plurality of line cards 20 accept the data from the management card 10 by way of the data bus 30 according to the control signals from the corresponding signal control lines 40.

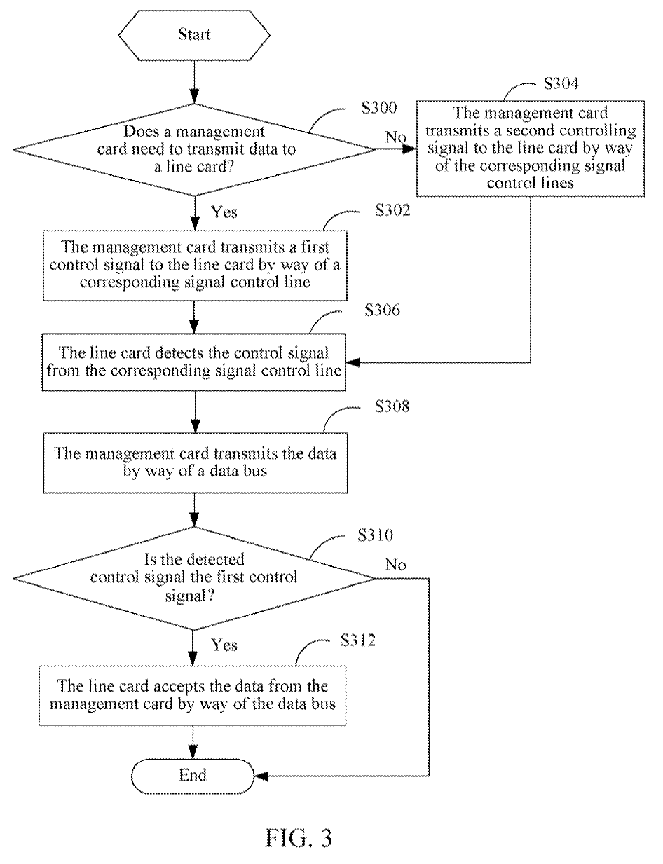

FIG. 3 is a detailed flowchart of the data transmitting method shown in FIG. 2. It may be understood that additional steps may be added, others may be removed, and ordering of the steps may be changed depending on the embodiment.

In step S300, the management card 10 determines if the management card 10 needs to transmit data to a line card 20.

If the management card 10 needs to transmit data to a line card 20, then in step S302, the management card 10 transmits a first control signal to the line card 20 by way of corresponding signal control line 40.

If the management card 10 does not need to transmits data to the line card 20, in step S304, the management card 10 transmits a second control signal to the line card 20 by way of the corresponding signal control line 40.

In step S306, the line card 20 detects the control signal from the corresponding signal control lines 40.

In step S308, the management card 10 transmits data to the line card 20 by way of the data bus 30.

In step S310, the line card 20 determines if the control signal from the corresponding signal control line 40 is the first control signal.

If the line card 20 determines the control signal from the corresponding signal control line is the first control signal, then in step S312, the line card 20 accepts the data from the management card 10 by way of the data bus 30.

If the line card 20 determines the control signal from the corresponding signal control line 40 is the second control signal, then the line card 20 does not accept the data from the management card 10.

As such, data from the management card 10 can be quickly transferred to the line cards 20 thereby improving the efficiency of transmission. In addition, replacing line cards is easy because only swapping the lines cards 20, that needs replacing, with the corresponding signal control lines 40 is needed.

Although the features and elements of the present disclosure are described as embodiments in particular combinations, each feature or element can be used alone or in other various combinations within the principles of the present disclosure to the full extent indicated by the broad general meaning of the terms in which the appended claims are expressed.

What is claimed is:

1. A network device, comprising:
a data bus;
a plurality of signal control lines;
a plurality of line cards corresponding to the plurality of signal control lines, wherein each line card connects to one corresponding signal control line; and
a management card configured for transmitting data to the line cards by way of the data bus and transmitting control signals to the line cards by way of the signal control lines;
wherein the plurality of line cards are configured for accepting the data from the management card by way of the data bus according to the control signals from the signal control lines.

2. The network device as claimed in claim 1, wherein the management card is further configured for transmitting a first control signal to one of the line cards by way of corresponding signal control line upon the condition that the management card needs to transmit data to the line card.

3. The network device as claimed in claim 2, wherein the management card is further configured for transmitting a second control signal to one of the line cards by way of corresponding signal control line upon the condition that the management card does not need to transmit data to the line card.

4. The network device as claimed in claim 3, wherein each line card is further configured for detecting the control signal from the corresponding signal control line.

5. The network device as claimed in claim 4, wherein each line card is further configured for accepting the data by way of the data bus upon the condition that the detected control signal is the first control signal.

6. A data transmitting method for a management card transmitting data to a plurality of line cards by way of a data bus, wherein the plurality of line cards corresponds to a plurality of signal control lines, and each line card connects one corresponding signal control line, the data transmitting method comprising:
the management card transmitting control signals to the plurality of line cards by way of the signal control lines;
the line cards detecting the control signals from the corresponding signal control lines;
the management card transmitting data to the line cards by way of the data bus; and
the plurality of line cards accepting the data from the management card by way of the data bus according to the control signals from the corresponding signal control lines.

7. The data transmitting method as claimed in claim 6, wherein the step of the management card transmitting control signals to the plurality of line cards by way of the signal control lines comprises:
the management card determining if the management card needs to transmit the data to one of the line cards; and
the management card transmitting a first control signal to the line card by way of corresponding signal control line if the management card needs to transmit the data to the line card.

8. The data transmitting method as claimed in claim 7, wherein the step of the management card transmitting control signals to the plurality of line cards by way of the signal control lines further comprises:
the management card transmitting a second control signal to the line card by way of the corresponding signal control line if the management card does not need to transmit the data to the line card.

9. The data transmitting method as claimed in claim 8, wherein the step of the plurality of line cards accepting the data from the management card by way of the data bus according to the control signals from the corresponding signal control lines comprises:
each line card determining if the control signal from the corresponding signal control line is the first control signal; and
the line card accepting the data by way of the data bus if the control signal from the corresponding signal control line is the first control signal.

10. A network device, comprising:
a plurality of line cards for executing various functions of the network device;
a data bus;
a management card configured for transmitting data to the line cards by way of the data bus;
a plurality of signal control lines each connecting one of the line cards to the management card for transmitting control signals from the management card to corresponding line cards;
wherein whether the line cards accept the data transmitted by the management card is determined by the control signals received by the line cards over corresponding signal control line from the management card.

11. The network device as claimed in claim 10, wherein the signal control lines are chip selection lines.
